(19) United States
(12) Patent Application Publication
(10) Pub. No.: US 2010/0015918 A1
(43) Pub. Date: Jan. 21, 2010

(54) WIRELESS TRANSFER OF INFORMATION USING MAGNETO-ELECTRIC DEVICES

(75) Inventors: Yiming Liu, Burlington, MA (US); Jesse Simon, Jamaica Plain, MA (US); Robert C. O'Handley, Andover, MA (US); Jiankang Huang, Arlington, MA (US)

Correspondence Address: RISSMAN HENDRICKS & OLIVERIO, LLP, 100 Cambridge Street, Suite 2101, BOSTON, MA, 02114, US

(73) Assignee: FERRO SOLUTIONS, INC., Woburn, MA (US)

(21) Appl. No.: 12/505,151

(22) Filed: Jul. 17, 2009

Related U.S. Application Data
(60) Provisional application No. 61/135,295, filed on Jul. 18, 2008.

(51) Int. Cl. H04B 5/00

(52) U.S. Cl. 455/41.1

(57) ABSTRACT

Apparatus and method for wireless near-field magnetic communication (NFMC) of information (e.g., voice or data) over modest distances (centimeters to a few kilometers). The transmission can proceed from an inductive coil transmitter to a magneto-electric (ME) receiving device, or between two ME devices. Electrical power may also be transmitted from and/or received using the same device. In one case, power and data are transmitted from an induction coil to a distant ME device that collects power and transmits data back to the power-transmission coil. In another case, the wireless transfer of data can be carried out between two ME devices. ME devices can be engineered to transmit or receive data and to receive electric power over a variety of frequencies by changing their dimensions, their material makeup and configuration, electrode configurations, and/or their resonance modes (longitudinal, transversal, bending, shear etc). Data rates up to and above several kilo-bits/s are possible using these methods with no limits on the frequency and duration of the communication.

### RELATED APPLICATIONS

This application claims the benefit of and incorporates by reference in its entirety U.S. Provisional Application 61/135,295 filed 18 Jul. 2008.

### BACKGROUND

There are growing needs for short-range, wireless communications in a number of diverse fields including but not limited to radio frequency identification (RFID), secure intra-person data transfer, implanted medical therapies and health monitoring, and collecting data from inaccessible sensors. However, communicating information wirelessly over modest distances (from a few cm up to several meters or even a few km) has remained problematic for a variety of reasons.

For two centuries voice and data have been transmitted via electromagnetic (EM) waves, either guided between a telegraph line and ground or propagating in the atmosphere on radio waves. Concurrently, electrical power has been transformed by electromagnetic (EM) devices (generators and motors). The transmitters of these technologies are based on Ampere's law in which a current through a coil generates a magnetic dipole field close to the coil; far from the coil (a distance greater than the wavelength), the field consists of both electric and magnetic field components with strengths in fixed relation to each other such that as the field propagates, it loses strength with distance on the order of r⁻². Alternatively, an electric dipole antenna can be used to transmit EM waves that are electric dipole waves close to the antenna and propagating EM waves far from it. The receiver of EM waves can be either a magnetic coil operating on the basis of Faraday's law or an electric dipole antenna. The laws of EM wave propagation were developed by Hertz and formalized mathematically in Maxwell's equations.

Wireless power transmission is generally done by inductive means, using coil-to-coil transfer. Historically, implanted medical devices have relied on externally driven flat coils, transmitting over a distance of a few cm to an embedded receiver coil [Van Schuylenberg, 1996; Schroeppl, 1998; Mann, 1999]. Low frequencies (typically in the range 30 kHz to 150 kHz) are used because of the low absorption of this band in body tissue. However, it is known that inductive coupling becomes increasingly less efficient as the size of the induction coils decreases.

Kurs et al. [2007] describe a wireless power transfer system based on two large induction coil antennae operating at about 1 GHz. At this frequency, the displacement charge in the coils (acting like dipole antennas) also contributes to the magnetic field generated by the current in the coils (acting like magnetic loop antennas). Power transmission of 60 W over about 3 meters distance is demonstrated. The hollow copper coils are about 0.6 m in diameter and require significant drive power. The skin depth of Cu at 1 G Hz is of order 2 μm, so there is considerable I²R loss in the Cu coil; all of the current is confined to a few microns at the surface of the coil.

Prior methods of communicating information for RFID or from inside the body to outside receivers are based on RF (frequencies of 125 kHz and 13.56 MHz) and make use of inductive or electric dipole antennas. For example, Yamada et al (2005) describe a method based on inductive coupling at 13.56 MHz. This frequency is an Industrial Science Medical (ISM) band using pulse-interval modulation (which provides inherently low data rates) to compensate for the high attenuation of RF radiation in body tissue. Their system consists of a large external coil and an implanted energy supply (charged wirelessly from outside the body by a small implanted pickup coil).

Jiang-Dong et al., [PCT KR2007/004344], describe an RF (several 100 MHz) means of trans-dermal communication with electrical signals conducted through the body tissue. Data is transmitted at “2 to 3 video frames per second” and in some cases up to 30 frames/s.

Musslvand [1996] describes an infrared system for transmitting data from inside the body to outside the body, and vice versa. Baud rates of 9600 are described, and the IR transceivers are about 2.6 cm in diameter, but power requirements of the implanted device are not described.

Propagating radio-frequency (RF) EM waves face challenges in circumstances such as underground communications and communication in and around large build structures due to dielectric absorption and metallic shielding. Absorption of RF waves by moisture and body tissue also present problems for this technology.

Another challenge facing any high-frequency EM signal for ground penetration or through-building communication, is the skin effect. Soil, rocks and build materials all have finite conductivity. When the alternating magnetic field is applied to those materials, an eddy current is generated and partly cancels out of the original magnetic field. This phenomenon is characterized by the skin depth of the material, which describes the magnetic field drop to 1/e of the field strength, without the material present. The skin depth is also related to the frequency of the magnetic field. In general the lower the frequency, the greater the field penetration is. Therefore, lower carrier frequency, which is an advantage for MEs but not for coils, is always preferred unless other considerations, such as data rate or noise issues, become more important.

It is known that non-propagating or near-field magnetic communication (NFMC) is much less prone to many of the problems that RF communications face. The near field is generally defined as the range within about one wavelength of the transmitting device. However, in the near field, both E and H signal strength drops off more rapidly (on the order of r⁻³) than the propagating electromagnetic waves (on the order of r⁻² ). For example, in free space, at a distance 100 meters from a current loop antenna which is 1 meter in diameter and with 10 ampere-turns, the magnetic field strength is calculated to be 3×10⁻¹² Tesla or on the order of pico-Tesla, (pT). To detect such a small magnetic field is a challenge.

Traditional coil-to-coil inductively coupled NFMC is a relatively mature and well-understood technology. However, for long distance NFMC, a few inherent drawbacks limit its performance. First, pick up coils respond to the time derivative of the magnetic field; for coils, higher frequency gives higher voltage and improved sensitivity. Operation at higher frequency brings problems for ground penetration of the magnetic field; low frequency gives better performance. Second, induction coils require many electrical turns to achieve high magnetic sensitivity; this adds resistivity, which increases electrical loss and reduces the device quality factor, Q. Lastly, the performance of a pick-up coil scales with its volume^{5/3}, so receive coils lose efficiency rapidly with decreasing size.

### SUMMARY OF THE INVENTION

In accordance with one embodiment of the invention,

an apparatus is provided comprising:

first and second devices adapted to communicate analog or digital information by wireless near-field magnetic communication (NFMC);

at least one of the first and second devices comprising a magneto-electric (ME) device having at least one magnetostrictive component bonded to at least one electroactive component.

The first device may comprise a transmit device that generates a magnetic dipole field at a carrier frequency that corresponds to a resonance frequency of the ME device.

The first device may further comprise a circuit for modulating a current or carrier frequency of the transmit device, said modulation carrying the information.

The second device may comprises an ME receiver device operable at the resonance frequency of the transmission from the transmit device.

The second device may further comprise a circuit that demodulates a voltage signal output of the ME device to reveal the information transmitted by the first device.

The ME device may further be adapted to wirelessly transmit or receive electrical power.

The ME device may have a resonance quality factor Q>100.

In one embodiment,

said first device is a transmit device and further comprises a circuit for modulating a current or carrier frequency of the transmit device, said modulation carrying the information;

said second device is an ME receiver device and further comprises a circuit for demodulating a voltage signal output of the ME receiver device to reveal the information transmitted by the first device.

The ME device may comprise a plurality of ME devices.

The ME device may include a bias magnet.

The ME device may be a thin-film deposition device.

The magnetostrictive component may be of an amorphous material.

The electro-active component may be of a hard, high Q piezoelectric material.

The piezoelectric material may be a PZT ceramic, single crystal relaxor, or quartz.

The information may be voice or data.

In a method embodiment, the method comprises:

a first device that transmits analog or digital information by wireless near-field magnetic communication (NFMC) to a second device;

the second device receiving said NFMC transmission from the first device;

wherein at least one of the first and second devices comprises a magneto-electric (ME) device having at least one magnetostrictive component bonded to at least one electro-active component.

The first device may be a transmit device that generates a magnetic dipole field at a carrier frequency that corresponds to a resonance frequency of a receiver ME device.

The second device may be an ME receiver device operable at the resonance frequency of the transmission from the transmit device.

The ME device may also wirelessly transmit and/or receive electrical power.

The information may be voice or data.

### BRIEF DESCRIPTION OF THE FIGURES

FIG. 1. is a schematic block diagram showing above, a piezoelectric layer (11) sandwiched by, and bonded (12) to two magnetostrictive layers (10); below, a bias magnet (13) sets the quiescent state of the magnetostrictive layers;

FIG. 2. is a schematic block diagram showing two means of wireless power and data transfer using ME devices; above, magnetic coil and ME; below, ME-to-ME power and data transfer; the reference numbers are directed to: 1: magnetic dipole antenna; 2: electric and magnetic dipole antenna; 3: magnetic dipole field; 4: power and data transfer; 5a, 5b ME transceiver; 6 electric and magnetic dipole fields; 7 power and data transfer;

FIG. 3. is a schematic block diagram showing a near-field magnetic communication system; the reference numbers are directed to: Input data: 22; Digital signal processor; 23: coil power supply, Class-D amplifier; 424: magnetic dipole antenna; 25a, 25b: ME receiver or ME receiver array at a distance; 26: Low-noise amplifiers for each ME; 27: demodulation id DSP; 28: expanded view of ME sensor;

FIGS. 4a and 4b are schematic block diagrams showing two means of connecting electrodes to the piezo to apply a voltage in order to stress the magnetic layers or to measure the voltage when the magnetic material strains; the reference numbers are directed to: 31a, 31b, 41a, 41b: magnetic layer (s); 32, 42: electroactive layers; 33a, 33b, 43a, 43b electrodes;

FIGS. 5a, 5b and 5c are schematic block diagrams showing three examples of different ME composites; the reference numbers are directed to: 51a, 51b : magnetic and 52: electroactive components: end-to end, magnetic rods in a piezo matrix, and magnetic sheath around a piezo fiber or rod; electrodes can be applied in a variety of different ways to each of these (and other composite geometries);

FIGS. 6a and 6b are schematic block diagrams showing two operational modes, namely low frequency bending modes, and higher frequency shear modes that can be excited in an ME device; the reference numbers are directed to: 61a, 61b, 64a, 64b magnetostrictive; 62, 63: electroactive.

FIGS. 7a, b, c are schematic block diagrams showing three methods of constructing shear-mode ME transducers; the reference numbers are directed to: 71a, 71b: magnetostrictive; 72 electroactive; 73a, 73b: electrode;

FIG. 8 is a schematic block diagram showing a circuit topology 80 of a resonant driving circuit;

FIG. 9 is a circuit block diagram showing a demodulation circuit 90; the portion enclosed by the dashed line is a lock-in amplifier, containing low-pass filters (LPF);

FIG. 10. is a graph of theoretical Signal to Noise Ratio (SNR) of a 75 kHz ME device (solid curve 102) and experimental results (line with data points 101) for an 18-inch coil and 1 W transmission power, plotted against distance(m);

FIG. 11. are two graphs illustrating the ME voltage (V) and coil drive current (A) for a communication from an ME device to the drive coil; the ME device is driven at resonance, while being subjected to alternating open-circuit/short-circuit conditions, leading to the alternating voltage on the ME in the upper plot; in the lower plot the resulting fluctuation in the current drawn by the drive coil is shown; the distance between the coil and ME was 20 mm;

FIGS. 12a and 12b are schematic block diagrams showing on the left, direction of E and H fields produced by an ME antenna, and on the right, direction of Poynting vector of propagating field emanating from the ME antenna; placement of a conducting plane close to one side of the ME antenna reflects much of the power to one side of the antenna; the reference numbers are directed to: 121a, 121b magnetostrictive; 122: electroactive components; 123, 124: orthogonal E and H fields;

FIG. 13. is a schematic illustration of a discontinuous electrical circuit made up of discrete ME elements 130a, 130b and 130c; the cylindrical ME elements could alternatively be planar laminated ME devices; the reference numbers are directed to: 131: magnetostrictive; 132 electroactive components; and

FIGS. 14a and 14b are schematic block diagrams showing a chip (left, FIG. 14a) or a chip-carrier (right, FIG. 14b) holding many chips and providing the power and data interconnects between chips; one or more coil transmitters can be provided near the perimeter to deliver a weak magnetic field at one or more frequencies (to address one or more ME receivers at resonance); the reference numbers are directed to: 141: chip; 142: ME power/data transceiver; 143a and 143b: coil transmitter; 144 4: chip carrier; 145: chip(s); 146: ME transceivers.

### DETAILED DESCRIPTION

Various embodiments will now be described for the wireless transmission of analog or digital information (e.g., voice or data) and optional power transfer accomplished with a system that includes ME receiver(s) and either coil or ME transmitter(s), plus electronics to power the transmitter and modulation and demodulation circuits to imprint information to the carrier wave and retrieve the information from it. The information may be any signal in analog or digital form and includes but is not limited to text, voice, graphics, video or other data.

While radio frequency (RF) communication has achieved great success over the past few decades, it still faces challenges in circumstances such as underground communications and or reception through large build structures due to dielectric absorption and metallic shielding. Near-field magnetic communication (NFMC), on the other hand, is very well suited for those environments. So far NFMC has been achieved through coil-to coil inductive coupling.

The present invention is a new means for wireless transfer of information (it also is capable of wireless transfer of electrical power) over modest distances from cm to a few km, depending on the components used. The information transfer occurs between an induction coil and an ME device or between magneto-electric (ME) devices.

An artificial or engineered ME device is a composite device that can function as an antenna for transmitting and/or receiving electromagnetic waves. ME composite devices are generally comprised of:

One or more layers of magnetostrictive material,

One or more layers of piezoelectric material,

Optional permanent or semi-hard magnetic material layer or layers for magnetic bias.

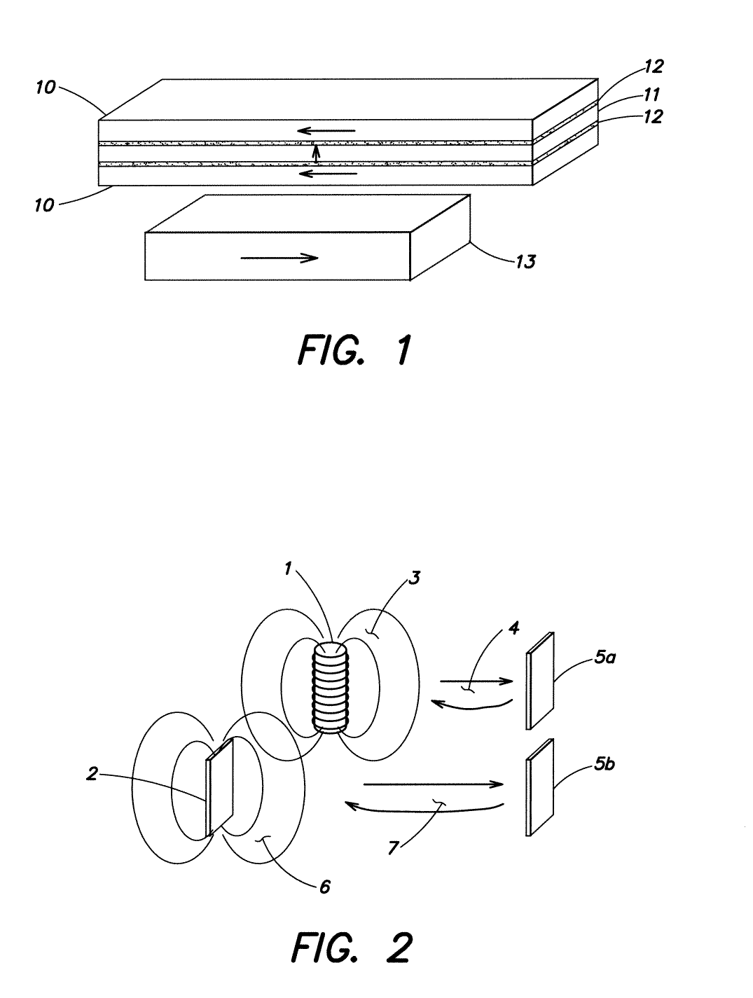

An example of an ME antenna is illustrated in FIG. 1. The magnetostrictive layers (10) are in intimate contact with the piezoelectric layer(s) (11). The small thickness and high stiffness of the bonding layers (12) assist in achieving optimal ME performance; however, separate bonding layers are not required, the bonding can be directly between the layers 10 and 11. The bias magnet layer(s) (13) need not be bonded to the other layers; they may function by being nearby but not bonded or in some cases bonded to the ME structure. Preferably, the magnetic material used has a significant magnetostriction and a very small magnetic anisotropy (or anisotropy field). Further, the ME device preferably has a very high quality factor, Q, for its magneto-electro-mechanical resonance (Q>100, even more preferably Q>500). The resonance frequency of the ME receiver determines the carrier frequency that the transmit antenna (coil or ME) will operate at.

FIG. 2 illustrates these two modes of operation, both of which include wireless energy transfer (4, 7) from transmitters (1, 2) via field(s) (3, 6) to an ME device (5a, 5b), and data transmission (4, 7) from the ME device (5a, 5b) back to the power transmitter (1, 2), the latter being either an ME device (2) or a source of magnetic field such as a magnetic coil (1).

Typically the transmit antenna, driven at the carrier frequency, is driven so that either the amplitude or frequency of the carrier wave is modulated in a pattern that replicates the information (e.g., data or voice) to be transmitted. The output voltage of the ME receiver is processed by a demodulating circuit to reconstruct the information.

The transmitter and receiver of the data are not connected by wires and may be separated by a distance that depends on i) the power and size of the transmitter, ii) the data rates required and iii) the engineering and materials design of the transmitter and receiver, one or both of which is an ME device. In addition to the three factors cited above, the communication range can be enhanced without scarifying data rate and using excessive power, by the use of high-sensitivity magnetoelectric (ME) transducers. The advantages of ME receivers over induction coil receivers are summarized as follows:
ME devices have both inductive and capacitive characteristics. Thus, an ME receiver can be configured to be resonant (its inductive reactance equal to its capacitive reactance) by changing its dimensions and materials without the use of an additional inductor or capacitor. Thus, its only source of loss in detecting data on a carrier wave is its internal loss. A coil receiver on the other hand requires a capacitor to make it resonant; the sources of loss come from both the coil resistance and the capacitor leakage.
An ME receiver scales much better at smaller size than does an induction coil antenna. A coil receiver is made more sensitive by adding turns and increasing its area; this increases its resistance (loss), its size and its inductance. The sensitivity of an ME device is proportion to its (volume)^{2/3} while that of a coil varies like (volume)^{5/3}.
ME transducers are compact in size. For example, a 75 kHz ME transducer measures about 1.25×0.5×0.1 cm³. This makes it practical to have tens or even hundreds of MEs arranged in an array. Each ME receiving element has its specific resonance frequency or carrier frequency, making high bandwidth communication possible.
ME transducers respond directly to a strength of the magnetic field and their signal increases linearly with frequency. Coil-based receivers, on the other hand, respond to the time-rate change of the magnetic field and their sensitivity increases with frequency squared. For that reason, coil receivers always work better for higher frequency and often contain many turns in order to achieve a substantial output signal. Increasing the number of turns increases losses associated with the resistivity of the wire. A simply-constructed ME transducer on the other hand can provide both high field sensitivity and low noise, across a broader range of frequencies.
For coil-based receiving antennas configured as resonators, the quality factor Q is inherently limited by copper losses, dielectric losses and magnetic core losses. Because an ME device is a mechanical resonator, its quality factor Q is intrinsically determined by the ME material properties and it can show much lower loss than a multi-turn coil with a magnetic core. Quality factors above 600 have been achieved with the present ME devices. An ME transducer having a quality factor of 1600 has also been reported. Higher Q is directly related to a lower intrinsic noise level and better suppression of environmental noise, which translates to longer communication distance and lower transmission power requirement.

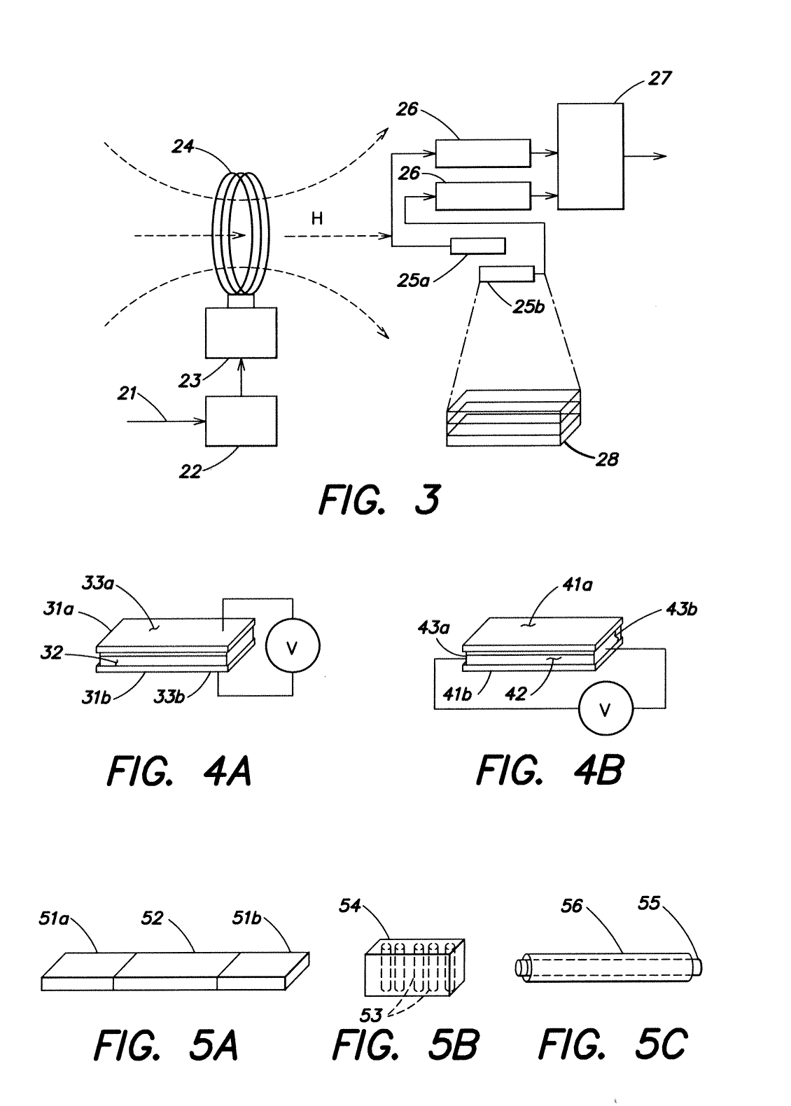

One embodiment of an ME-based wireless NFMC system is illustrated in FIG. 3. The system is composed of coil transmitter and ME transducer (or ME array) receiver. On the transmitter side, the digital data (21) is first fed into a digital signal processor (DSP) (22), where the data is spilt into a lower data-rate stream that is imprinted on the carrier frequencies by a selected modulation scheme. Those carrier frequencies are chosen to correspond to the resonance frequencies of individual ME transducers. The modulated signal is then mixed and fed into a high-efficiency, class D or switch model amplifier (23) to drive the coil antenna (4 24). The current through the coil generates the magnetic field to be picked up by ME transducer array at some distance from the transmitter. On the receiver side, multiple ME transducers (25a, 25b) are designed so that each one has a distinctive resonance frequency corresponding to a particular carrier frequency. ME transducers have a very high quality factor and act like narrow band filters. Only the magnetic signal that falls into the band of a particular ME receiver will generate a signal. The signal is then amplified through low noise amplifier (LNA) (26a, 26b). All the ME transducer signal is streamed into a DSP unit (27), where the original data is reconstructed. A small ME receiver (about 0.1 cm³ in volume) has been demonstrated to resolve data from a 1 Watt transmit coil at a distance of 150 meters (m) from the transmitter. At this distance the strength of the magnetic field (at the carrier frequency) is less than 0.1 pT. To achieve a similar sensitivity with a coil receiver would require a coil with a much larger area and many turns, as well as a capacitor to make the receiver resonant with the carrier frequency.

Table 1 lists some preferred materials for use in the magnetic and electroactive components of the ME device and their relevant parameters. The sensitivity of an ME receiver (i.e., the output voltage per unit of strength of the magnetic near-field to be sensed) depends on the magnetoelastic stress coefficient, B₁, and the effective anisotropy field, Hₐ^{eff}, of the magnetic layer, the stress-voltage coefficient, gᵢⱼ, of the electroactive component, and the quality factor, Q, of the ME device.

TABLE 1
Magnetoelastic stress coupling coefficient, B₁, and stress-voltage
coupling coefficients, g₃₁, for preferred magnetostrictive and electro-
active materials and the resulting theoretical sensitivity, S, for an
ME device having an electrode spacing of order 1 mm (V = S H₀/Hₐ).

| | B₁ | g₃₁ |
|---|---|---|
| | (MPa) | (V/Pa-m) |
| Amorphous magnetostrictive (e.g. Fe₇₀Co₁₀B₁₈Si₂) | 3.5 | — |
| Amorphous magnetostrictive (e.g. Fe₄₀Ni₄₀B₁₈Si₂) | 2.0 | — |
| PZT -8 (Lead-zirconate-titante) | — | 0.015 |
| PMN-PT (Pb—Mn-niobate - Pb-titanate) | — | 0.1 |
| Quartz (SiO₂) | — | 0.001 |
| Zinc-oxide | | 0.0014 |
| Aluminum-nitride | | 0.0009 |

The design of the ME transceiver devices can be varied by several means to tailor the data transmission frequency, range and data rate. These design changes include, but are not limited to the following factors.
1) The materials selected for the magnetic and piezoelectric components of the ME transceivers can significantly alter device performance characteristics.
The magnetic components of the ME can be chosen from a variety of amorphous magnetic materials based on one or more of the elements Fe, Co, and/or Ni plus 15-25% of glass forming elements such as B, Si, P, Al, and/or C. Up to 10 atom % of Mn, Cr, V, Mo or other transition metals as well as rare earth elements (Tb, Dy, Gd, Er, Sm or some mixture of these and other rare earth elements) may also be added to tailor specific properties of the ME device. The magnetic composition chosen can be fabricated to have an amorphous structure in order to maintain high Q.
The piezoelectric elements of the ME device may also be chosen from a variety of sources including “hard” single crystal or ceramic lead-zirconate-titanate (PZT or PZT-8), PMN-PT relaxor crystals, crystalline quartz (SiO₂), aluminum nitride, or lead-free oxide compounds. The bias magnets may be commercially available semi-hard materials (coercivities between 20 Oe and 400 Oe) such as Arnokrome® or Crovac®. Alternatively the bias magnet may be designed from a selection of transition metals (3d, 4d and 5d) as well as rare earth metals (4f) plus minor additions (<10 at %) of other species such as B, C, Si, Mo, Cr, V, and Mn.
Any of these materials may be of bulk form or they may be made by a thin-film deposition technique such as sputter deposition, liquid or vapor phase epitaxy, spin-coating, evaporation, sol-gel techniques, etc.
2) Also a factor in the resulting performance of an ME device is the direction in which the piezo is poled (relative to its electrodes) and the direction in the magnetic layer in which the magnetization prefers to lie (e.g. if there is a shape anisotropy or field-induced anisotropy). These directions are determined based on the material properties, geometry and the preferred direction of transmission. Further, a bias magnetic field may be used to reduce noise and enhance signal strength. It can be applied by placing or growing one or more thin permanent or semi-hard magnetic layers adjacent to the magnetostrictive layers. Preferably the magnetic layers of the ME device are field annealed to have a weak anisotropy easy axis transverse to the direction of the magnetic field component of the carrier wave. Further, the magnetic layer are preferably biased by a longitudinal field to achieve a magnetization state close to but below saturation for optimal sensitivity, dV/dH(t)gᵢⱼB₁/Hₐ.
3) Electrode configuration can be such that the piezo voltage is applied (or generated) across closely spaced or more-distant spaced surfaces. The vector between the electrodes and the direction of principle strain of the composite can be perpendicular to each other (g₃₁ configuration, see FIG. 4a,) showing voltage V applied across top and bottom electrodes 33a, 33b on a composite having magnetic layers 31a, 31b and electroactive layer 32) or parallel to each other (g₃₃ configuration, see FIG. 4b, showing voltage V applied across end electrodes 43a, 43b of a similar composite having electroactive layer 42 between top and bottom magnetric layers 41a, 41b). This choice affects the voltage output V of the ME receiver (and may be used to match the load impedance); the choice of electrodes can also affect the noise generated by the device.
4) While layered (laminated) ME composites are commonly used for ME sensors and receivers, other composite geometries have advantages in different circumstances. These include end-to-end configurations (for lower frequency receivers, (e.g. electroactive component 52 between magnetic components 51a and 51b, as shown in FIG. 5a), magnetic rods or “spheres” in a piezoelectric matrix 54 as shown in FIG. 5b, and coaxial designs (a piezo-electric fiber 55 clad by a thin magnetostrictive layer 56 as shown in FIG. 5c).
5) Factors 1)-4) can each alter the fundamental resonance frequency (and in many cases the distribution of higher harmonics) of the ME device as well as the output voltage and current generated across the piezo. For an extensional mode along a dimension of length L of the laminated ME, the resonance frequency is given by

$${f}_{r} = \frac{1}{nL} \sqrt{\frac{{E}_{eff}}{{ρ}^{eff}}} \qquad ( 1 )$$

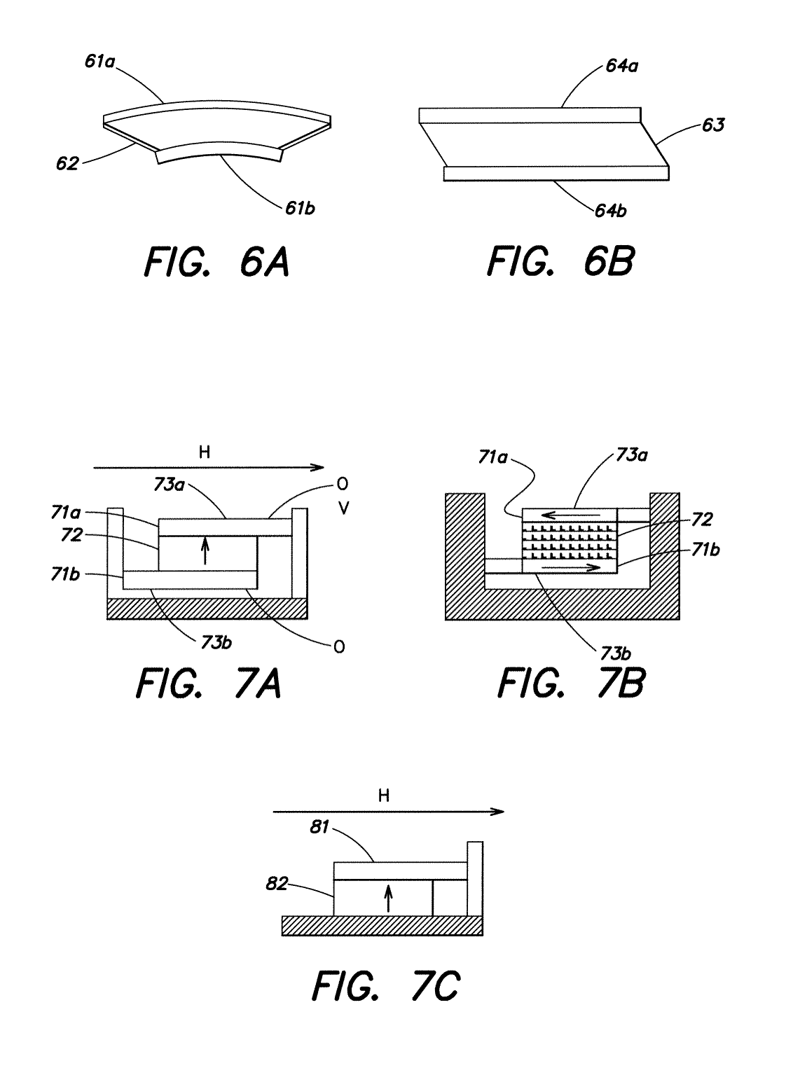

Here n depends on the boundary conditions on the ME in longitudinal motion. The extensional mode in a 1 mm ME device is in the range 1-2 MHz. Bending modes occur at much lower frequencies than extensional modes and they depend on the width and thickness as well as the length of the ME element (see FIG. 6a showing electroactive layer 62 between top and bottom magnetostrictive layers 61a, 61b). The bending resonance frequency is given by:

$${f}_{bend} = \frac{h}{4 π {f}^{2}} \sqrt{\frac{\tilde{E}}{\tilde{ρ}}} \approx 100 kHz \qquad ( 2 )$$

For a 1 mm-long cantilever the bending mode is at about 100 kHz. The exact values of these frequencies depend on the modulus and density, relative layer thicknesses, hᵢ, as well as other dimensions.

Resonance modes that depend mainly on the ME thickness (or thicknesses of individual layers), such as shear modes (see FIG. 6b showing electroactive layer 63 between end magneto-strictive layers 64a, 64b), or thickness extending mode, appear at much higher frequencies because they depend on the ME thickness, not length. Shear modes can be excited magnetically using magnetostrictive materials of different, or ideally opposite, magnetostriction coefficients on the opposing layers. They can be excited electrically by placing electrodes on the piezo element appropriately to excite the desired mode. In each case, the electric and magnetic fields radiated will take on different configurations.

The advantages of g₁₅ or other shear modes for ME communications devices is that they can be driven at much higher frequencies without changing the length of the ME structure. This is because the frequency of these shear modes can depend on the piezo thickness or width, as well as its length.

Shear modes can be excited in MEs in which the top and bottom electrodes 73a, 73b applied to top and bottom magnetostrictive layers 71a, 71b stress the piezo 72 in opposite senses in the field (FIGS. 7a, and b). The field causes the two identical magnetostrictive elements (71a, 71b) to elongate and contract in phase with each other. However, because they are supported on opposite surfaces the elongation of each element is in the opposite direction relative to the other.

A simplification of FIG. 7a that has advantage for microfabrication or simpler bulk fabrication is shown in FIG. 7c. Here the piezo (82) is constrained on its bottom surface and is driven by a single magnetostrictive layer (81) on the top surface (a continuous magnetostrictive layer is illustrated here but it could be a magnetostrictive layer (71) connecting to an electrode layer (73a) on the top surface of the ME as illustrated in FIG. 7b).

Thus, there are many parameters that can engineered to control, tailor and refine the performance of ME transducers and they will be chosen based on the desired application, environment, operating frequency and expected range of transfer for the wireless data (and power) to take place. It is also possible to transfer data at one frequency and power at another.

Inductive Transmitter

A major design consideration for a resonant magnetic-dipole transmission antenna is the trade-off between the magnetic field that can be generated by a given current, and the antenna inductance; both increase as the number (N) of turns increases, varying like N and N², respectively. If the inductance is too high, the terminal voltage of the coil could exceed the capacitor voltage rating (the capacitor is needed for resonance of the inductive coil). On the other hand, if the number of turns is reduced, a given field strength could require a larger current than would be practical for power transistors. A 3-turn, 18 inch diameter inductive transmit coil adapted for long-range communication is suitable. The major advantage of this antenna is that it has low inductance, L≈3 uH, and it can be driven directly by a linear amplifier. The coil windings are made of 9 strands of Litz wire, each of these containing 550 strands of 44 AWG copper wire. The large cross-sectional area of copper reduces the DC resistance, while the insulated, fine strands reduce the AC resistance by reducing the skin effect. The calculated DC resistance is 16 mΩ and AC resistance is 19 mΩ at 75 kHz.

The coil shape can be clamped by adjustable rods to change the shape of the coil thus fine-tuning the inductance to match the ME resonant frequency. The tunability is about 5% around 52 uH. This coil antenna is used with a resonant driving circuit to achieve low power transmission.

Circuits

Each of the system components (ME/ME or ME/coil antenna) has its own circuit. The transmit device has a circuit to excite the ME or loop antenna.

If it is data that is being transferred, the excitation of the transmit coil (usually an ME element), must be modulated in some fashion to carry digital or analog information. In receiving data, there needs to be a means of electronically interpreting and storing the information, and in most cases, acting upon it (readout, command of other function, or alarm). If it is power that is being transferred, the circuit must match the impedance of the transmitting element and deliver the power at the resonance frequency, fᵣ, needed for the range of transmission. In receiving power, the raw, AC signal from the receiving element may need to be rectified and conditioned, then stored or divided between use and storage.

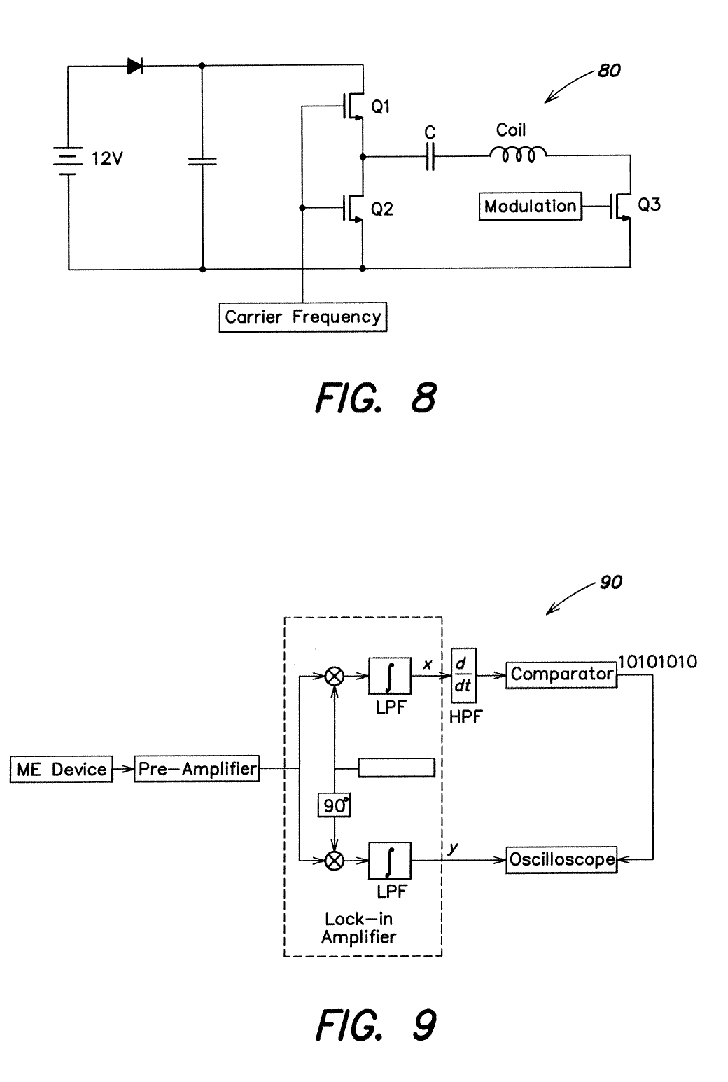

An exemplary topology 80 of a driving circuit for a resonant coil, including modulation functionality, is illustrated in FIG. 8. In this circuit, Q1 and Q2 constitute a half-bridge drive in synchronization with the carrier frequency. The capacitance C and antenna coil inductance are tuned to match the resonant frequency of the ME transducer. When the carrier frequency is tuned to that frequency, a very large current may be generated with a relatively small power supply voltage. Another feature that may be incorporated into this driving circuit is enhanced on-off-keying modulation. Without it, the modulation can be done by turning the carrier frequency on and off, however doing this will require a relatively long time for the current to build up and ring down. Using an enhanced modulation circuit, Q3 is used to stop the current and preserve charge on the capacitor C when the field is switched “off” by disconnecting the capacitor from ground. When the next “on” signal comes, Q3 and Q2 will be turned on in synchronization and the LC circuit will start to resonate at full power within a few cycles of the carrier frequency.

Modulation/Demodulation

A variety of modulation schemes can be employed to imprint data on the ME carrier frequency. For example, Amplitude Shift Key (ASK) or On Off Key (OOK) modulation can be used with the following considerations:
1. Data rate: ASK/OOK needs ⅔ of the bandwidth required by Frequency Shift Key (FSK) for the same data rate, assuming the minimum criterion for good noise performance.
2. Sensitivity: It is commonly believed that FSK receivers are more sensitive than OOK receivers. However, if properly implemented, OOK can actually outperform FSK in both sensitivity and interference tolerance using coherent or synchronous demodulator.
3. Power requirement: One of the most attractive features of ASK/OOK is that for the same communication distance, it uses less than 50% of the power used by FSK.
4. ASK/OOK: simple to implement on both transmitter and receiver ends. ASK/OOK: does not need accurate timing and therefore is more robust.

One possible modulation circuit is 90 illustrated in FIG. 9. The drive current was modulated with a 100 Hz square wave. The ME receiver was 10 meters away. The ME signal was first amplified using a pre-amp and the signal was fed into a Stanford Research SRS830 lock-in amplifier. The lock-in amplifier can be viewed as a coherent demodulator in this case, with the output x and y channels of the amplifier corresponding to the in-phase and quadrature signals in quadrature demodulation. Because the frequency of the local clock of the lock-in amplifier is always slightly different from the carrier frequency, there will be a sinusoidal component to the signal with a frequency equal to the difference between the carrier and clock frequencies. A high-pass filter (HPF) was used to remove this sinusoidal component. The output of the high-pass filter was then fed into a comparator, which discriminates between 1 and 0 given a certain threshold voltage.

Inherent Noise of ME Receiver

A critical figure of merit for a communication receiver is the signal-to-noise ratio (SNR), which fundamentally determines the viable transmission distance for a given signal strength. Any receiver will be subject to both intrinsic and environmental noise sources. There is also intrinsic noise in a piezoelectric material, also called electrical-thermal noise, which is related to the dissipation factor, η, or loss tangent of the piezoelectric material [Rowan et al. 2005]. The dissipation factor η for piezoelectric materials is in the range of 0.001 to 0.005. This noise decreases with increasing frequency. The contribution to the intrinsic noise from the magnetostrictive material is called the magneto-mechanical noise. It is associated with magnetic loss and is represented as a complex susceptibility X=X′+ⁱX″. In a transverse field-annealed magneto-strictive material, the magnetization change in response to an applied field is predominantly associated with lossless magnetic rotation. Any domain wall motion that takes place will contribute significantly to the magnetic noise (as well as reducing the sensitivity of the device); this may be eliminated through careful material selection and annealing techniques. The square of the total noise from ME device is determined by the sum of the squares of all the noise components.

Signal Sensitivity of ME Receiver

The voltage output V of an ME receiver at a distance r from a transmission coil antenna of radius a can be approximated as

$$V \approx SNI \frac{π {a}^{2}}{{r}^{3}} \qquad ( 3 )$$

Here S is the combined sensitivity of the ME transducer and preamplifier, N is number of turns of the transmission coil, and I is the current of the coil. If the noise floor of ME device is V₀^{noise}.The signal-to-noise ratio SNR determines data capacity. The SNR written in dB is

$$SNR = 20 Log ( SNI \frac{π {a}^{2}}{{r}^{3} {V}_{0}^{noise}} ) \qquad ( 4 )$$

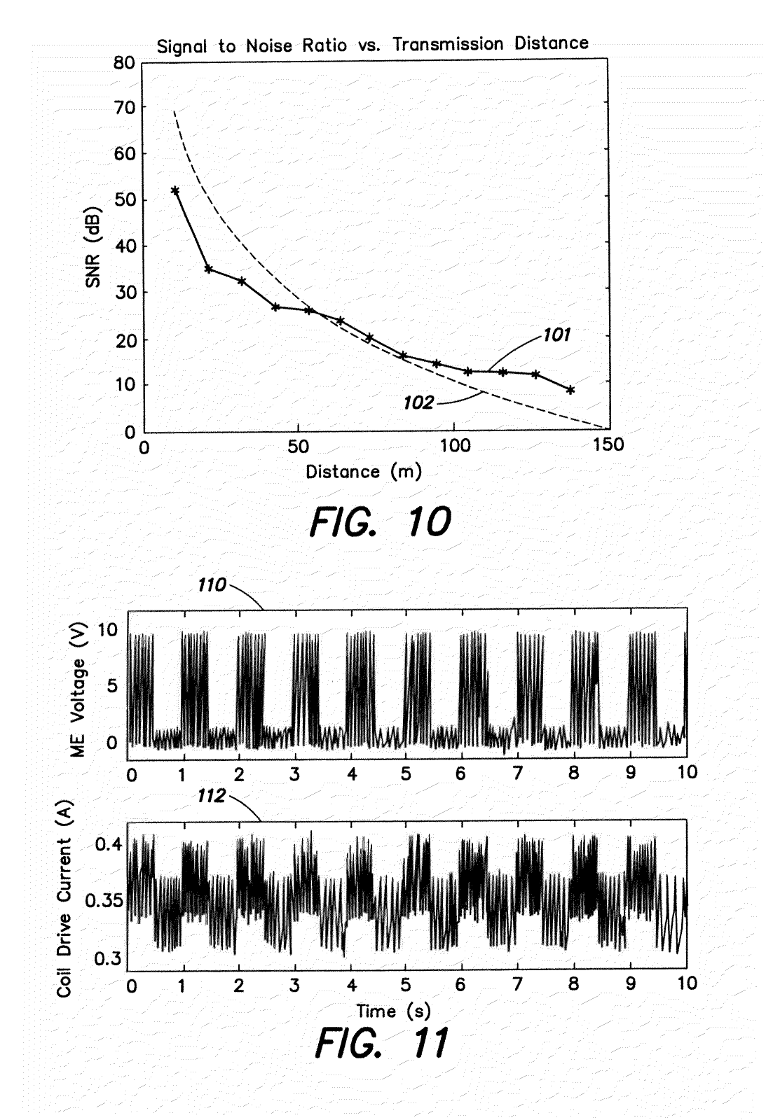

In FIG. 10, the curve 101 through the data points shows the experimental SNR measured on a transmit-coil/ME-receiver system with a transmission current of 2A_{RMS}. The other curve 102 shows the SNR calculated from Eq. 4 using the parameters of the measured system. It is interesting to note that beyond a distance of about 60 m, the measured SNR exceeds the theoretical value. This may be due to the fact that the experiment was performed outdoors where multiple vehicles and buildings were nearby. Any magnetic material (e.g. steel) in these objects will act to distort the transmitted field; since the permeability of these objects is higher than that of air, they can act to concentrate flux lines in the high-permeability object to the detriment of the nearby space. This distortion or redistribution of the magnetic field can enhance or decrease the signal picked up by a nearby receiver, depending on its location and orientation.

The receiving bandwidth (BW) is related to the ME receiver's quality factor Q as:

BW=f_{c}/Q (5)

where f_{c} is the carrier frequency. According to the Shannon-Hartley theorem, the channel capacity C in bits per second is given by

C=BW×Log₂(1+SNR) (6)

Here, the signal, S is the total signal over the bandwidth and the noise, N is the total noise signal over the bandwidth, both measured in Volts. The theorem shows that when the SNR is reduced, the bit error rate increases, therefore more and more retransmission is required and the channel capacity decreases.

ME for Two-Way Communication: ME-to-Coil

It is possible to transmit data from an ME device implanted in the body or otherwise inaccessible, to an external power transmit coil or to another ME device. Using a function generator connected to a switching transistor, the ME element was subjected to alternating open-circuit/short-circuit conditions. The ME element was tuned and detuned from its resonant frequency by the changing load. The resulting change in coupling between the coil and the ME element was detected as a fluctuation in the drive current drawn by the coil, which was driven at a constant AC voltage. In FIG. 11, the upper plot 110 shows the fluctuation in voltage on the ME device as it is switched between open- and short-circuit conditions. The lower plot 112 shows the DC current into the drive circuit, which also changes as the load on the ME is modulated.

What is unique about an ME transmitter is that, in addition to the electric field generated by the polarization current between the electrodes, the magnetization change in the M layers contributes a strong magnetic component to electromagnetic wave generation even in the near field. Thus, an ME is a totally new type of EM antenna for both E and M components in the near-field as well as conventional far field EM radiation.

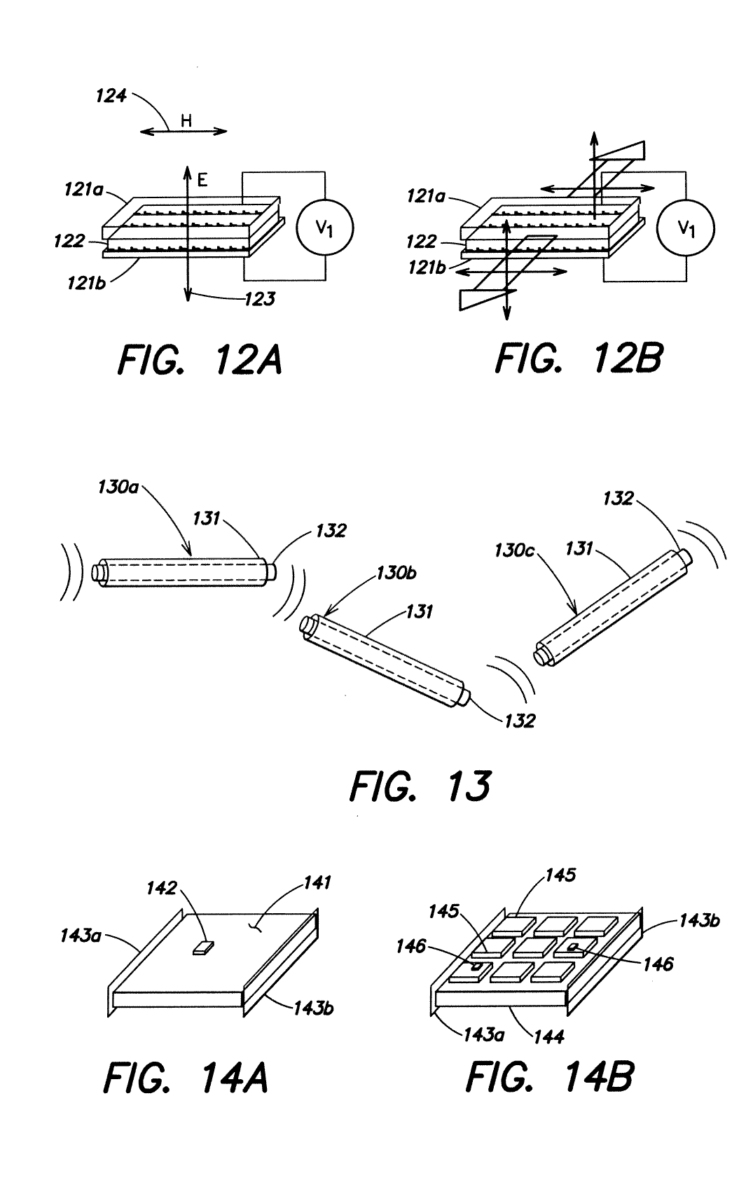

An ME antenna thus radiates mainly in the two directions along the axis normal to the plane containing both E and H (see FIG. 12a left, showing piezo 122 between top and bottom magnetostrictive layers 121a, 121b). If a ground plane is placed near one side of the ME, then nearly all of the radiated energy can be transmitted in one direction, (see FIG. 12b, right). Thus, radiated power can be more heavily concentrated in a specific direction.

Arrays of these ME antennas may also be utilized, as well as mechanisms to steer the beams by rotating the ME device(s) or changing the relative phase of devices in an array.

Another distinctive advantage of the ME element as an antenna is that the electrical driving circuit is much more efficient, compared to that for an inductive coil. This is because the electric voltage is applied to the piezoelectric material, which has a high impedance. Therefore, the impedance of the driving circuit is easily matched to that of the ME antenna, without complex matching networks. Further, the voltage (and charge) across the piezo is in phase with its strain, but the voltage is close to 90 degrees out of phase with the current; this minimizes electrical loss in the driving process.

### Applications

The following are examples of applications which can benefit from the previously described aspects of the present invention.

Radio-Frequency Identification (RFID)

Radio-frequency identification (RFID) is a means of wirelessly identifying products in a store or factory or controlling access to a site etc. for the sake of inventory control, theft deterrence or security. It is growing in use and the opportunities for it are far from exhausted. However, current practice limits the range over which labels or tags on an item can be identified and read, as well as the amount of information that can be exchanged between the item and the reader. Having a means of transmitting power simply and efficiently with a small device would greatly accelerate the implementation of this important RFID technology. By using a small inexpensive ME element in each product or item to be identified, a remote antenna (coil or ME) could deliver power to the ME label and communicate with it for a variety of purposes. ME technology appears to be more suitable to this application than pure inductive or RF communication because of its generally lower absorption and its increased efficiency at small scales.

Medical In-Vivo Wireless Monitors

A growing number of in-vivo medical therapies, such as electro-stimulation or localized, active drug delivery, for treatment or management of chronic pain, migraine, epileptic seizure, Parkinson's syndrome, to name a few, are gaining increased acceptance. The use of in-vivo electrical therapies and monitors is expanding rapidly because of the reduced cost and fewer side effects of electro-therapies and the reduced cost and more timely feedback of in-vivo patient health monitors.

Intra-Person Wireless Communications Networks

There is a growing need for more secure and efficient means of intra-personal wireless communication to link devices carried by soldiers, safety officers, rescuers, the elderly and infirmed. Near-field communication is recognized as a prime candidate to meet this need. Clearly, ME-to-ME coupling can allow communication over a wireless network over a range appropriate for this application, and do so with very little power consumption and using small devices. In this sense it can function like current “Blue-tooth” devices.

There are also many personal communications systems that could benefit from use of ME-based magnetic near-field communications. These include wireless, hands-free ear-sets for cell phones or MP3 players, replacing “blue-tooth” devices. Also applicable are smart cards for communication of personal financial or business data wirelessly to selected receivers at a short distance.

Less-Densely-Wired Integrated Circuits

There are many applications where it is desirable to conduct electricity (to either transfer data or power or both) over a small distance without a continuous wire. Power and data conductors are found with the greatest density in integrated circuits for logic and processing, as found in computer microprocessors and IC power and DSP circuits. FIG. 13 illustrates this concept with a series of coaxial ME elements 130, including piezo fiber 132 clad by magnetostrictive layer 131. The ME elements may be of a different design than the cylindrical ones shown here, and their size, scale and spacing may vary from micron scale to cm scale. The ME elements themselves may also be flexible in one or two directions, for example by making them out of PVDF or quartz (fibers or films) having thin layers of magnetostrictive metal deposited thereon. Further, a broadband transmitter could emit signals at several different frequencies and they would be detected only by the ME receiver having the appropriate resonance frequency.

One application of such a discontinuous ME circuit or ME-coil system may be to replace solid conducting lines (that are prone to heating, shorts, open circuits, and electromigration) in integrated circuits (ICs). Elimination of such lines would greatly simplify the fabrication of IC chips and chip carriers, which are extremely dense in conducting lines and vias to carry power and signals. In particular the density of power conductors in ICs is one of the reasons for their high operating temperatures and, consequently, shorter time-to-failure. Such wireless ME interconnects could be used on a single chip (see FIG. 14a with ME power/data transceiver 142 on a single chip 141 between coil transmitters 143a, 143b), between chips and chip carriers (which would enable chip-to-chip wireless power and communication), as well as between chip carriers, boards etc. as suggested in FIG. 14b (see ME transceivers 146 on multiple chips 145 on chip carrier 144 between coil transmitters 143a, 143b).

Additional Embodiments

Set forth below are various additional embodiments of the invention.

In one embodiment, a magnetic near-field communication system is provided comprising:
a transmit device (preferably a current-carrying coil of wire) that generates a magnetic dipole field at a carrier frequency that corresponds to the resonance frequency of a magneto-electric (ME) receiver;
a circuit that modulates the current through the transmit coil or that modulates the carrier frequency of the transmit device, said modulation carrying information (e.g., voice or data);
a magneto-electric receiver not electrically connected to the transmitter, and at some distance from the transmitter ranging from a few cm to several hundred meters;
said magneto-electric device comprised of a combination of magnetostrictive and electro-active components that together result in a high-quality-factor resonance (Q>100), at a frequency to which the transmitter is matched;
a circuit that demodulates the voltage signal output of the magneto-electric device to reveal the information sent to it wirelessly from the transmitter.

In this system, the ME device can also receive electrical power wirelessly from a transmit coil or from another ME device in addition to receiving information.

The system may also include one or more bias magnets adjacent to the ME device.

The carrier (resonance) frequency may be amplitude modulated (amplitude shift key, ASK or on-off key, OOK) to carry information.

The carrier (resonance) frequency may be frequency modulated (frequency shift key, FSK) to carry information.

The components may be magnetostrictive (M) and electroactive (E) layers of a composite made by a thin-film deposition or growth processing method.

A bias layer may be made by the same or other processing method.

In another embodiment, a magneto-electric (ME) composite is provided that has cylindrical symmetry and consists of either a central piezoelectric element clad in a magnetostrictive layer and having electrodes on the ends of the piezoelectric layer or discrete electrodes distributed along the length, or a cylindrically-symmetric ME device is provided comprising a central magnetostrictive metal fiber at its core, surrounded by a layer of piezoelectric material, which in turn is surrounded by a second metallic magnetostrictive metal layer, and the two magnetostrictive layers act as electrodes for the piezoelectric. One or the other of the metallic magnetostrictive layers may be replaced by a conducting layer to act as an electrode.

The magneto-electric composite may include a piezoelectric matrix with collinear rods of magnetostrictive material passing through it.

The magneto-electric composite may include a piezoelectric matrix with particles of magnetostrictive material embedded in it.

The magneto-electric composite may act as a transmitter of electrical power and/or information, as well as a receiver of information and/or power.

The magnetoelectric device may couple wirelessly to an inductive coil or loop antenna such that the two can exchange information and/or power.

In another embodiment, a method is provided for using a wireless electrical power system, including an external coil, and implanted ME device to effect information transmission from inside the body via the ME device to the external induction coil.

In another embodiment, an ME antenna is provided that can be used for both transmission and reception of near-field electromagnetic waves.

The ME antenna can be used with a conventional magnetic loop antenna or as a coupled ME/ME pair, either one transmitting and the other receiving information and/or electrical power.

The ME antenna may have a mechanical resonance frequency that is close to the dominant/carrier frequency of the electromagnetic wave.

The ME antenna may communicate power and/or information with another ME transceiver or coil at various resonance mode frequencies such as, longitudinal mode, thickness mode or shear mode etc.

In another embodiment, a series of discrete (not connected by electrical wires) ME transceivers is provided whose resonance modes are coupled so that they form a network or wireless circuit for information and/or power transmission among the multiple ME transducers.

The ME network may act in the body for delivery of power and/or information for medical therapy and/or monitoring.

The ME network may couple a distributed network of sensors.

In another embodiment, the ME devices may be used to facilitate RFID applications to transfer information and/or power wirelessly between a hand held device and an item on a shelf or in a package for the purpose of inventory control or theft detection.

In another embodiment, the ME devices may be provided in personal electronic devices and induction coil(s) are embedded or located in a pad or basket such that the personal electronic devices can be wirelessly recharged at different rates and impedances appropriate to each device. The personal devices can communicate information to the coil in the pad or basket and contain a rechargeable battery and an ME transducer.

In another embodiment, the ME devices may be electromagnetically coupled to form a winding-free (wireless) isolation transformer, or step-up transformer or step-down transformer.

In another embodiment, the ME devices are used to select signals at certain frequencies (their coupled ME resonance frequency) from a broadband transmitter.

In another embodiment, a group of ME devices is used to replace electrically conducting power and/or information interconnects in an IC chip, or between an IC chip and a chip carrier, or between IC chips, or between IC chip carriers, or from chip carriers to a board. The wireless power can be provided to or delivered to one or more ME receivers from the magnetic near field of a coil or coils outside the chip, chip carrier, or board and not connected to the ME by electrically conducting wires.

In another embodiment, the near-field flux density around an ME device is used to transfer electrical power and/or information to a nearby ME receiver or induction coil

In another embodiment, an ME antenna, driven by a time-dependent voltage or stress, is used to generate a propagating far-field electromagnetic wave.

The impedance of the field, closer than one wavelength to the ME antenna, may be between 250 Ohms and 450 Ohms or between 200 Ohms and 500 Ohms.

The ME antenna may transmit significant electromagnetic energy and/or information over an electromagnetic wave over distances greater than the range of non-radiative, near field electric or magnetic field components.

In another embodiment, ME transducers may be used to relay information (as in “blue-tooth” technology) and/or power between an ear-piece, or headset speaker and a hand-held or an otherwise remote device (cell phone, PDA, MP3 player, i-Pod, car radio, telephone land line, sensor, etc.).

In another embodiment, a ME device is used in a hearing aid to convert the acoustic-frequency magnetic field of an incoming telephone message to a voltage to directly drive the amplifier of a hearing aid.

The ME device may detect the proximity of a telephone handset in order to signal a hearing aid to switch to a lower-gain “phone” mode.

In another embodiment, the ME device may charge the batteries in a hearing aid, an implanted electrical stimulator, pump, valve, pacemaker, or other medical device.

In another embodiment, the ME device or devices may communicate information between smart cards or between a smart card and a reader for the purpose of identification, access control, exchange of business card or personal data, notification/recognition, or for credit/debit functions.

### REFERENCES

Kurs et al. “Wireless power transfer via strongly coupled magnetic resonances”, Science 317,83 (2007).
Mann, C., Advanced Bionics, “Transcutaneous transmission patch”, U.S. Pat. No. 5,948,006, Sep. 7, 1999 and 6,275,737, Aug. 14, 2001.
Musslvand T., “Biotelemetry application for remote patient care”, International Society of Technology Assessment in Health Care. Meeting (1996).
   http://gateway.nlm.nih.gov/MeetingAbstracts/ma?=102222513.html
Rowan, S., J. Hough, D. R. M. Crooks ‘Thermal noise and material issues for gravitational wave detectors’ Physics Letters A 347 (2005) 25-32
Yamada, T., T. Uezono, K. Okada, K. Masu, A. Oki and Y. Horiike, “In vivo batteryless wireless communications system for bio-MEMS sensors”, Jpn. J. Appl. Phys. 44 (2005) pp. 2879-2882.
Schroeppel, E., P. Spehr, Sulzer, “Transcutaneous energy coupling using piezoelectric device”, U.S. Pat. No. 5,749,909, May 12, 1998.
Van Schuylenbergh, K, and R. Puers. “Self-tuning inductive powering for implantable telemetric monitoring systems”. Sensors and Actuators A 52, 1-7, (1996).

1. An apparatus comprising:
first and second devices adapted to communicate analog or digital information by wireless near-field magnetic communication (NFMC);
at least one of the first and second devices comprising a magneto-electric (ME) device having at least one magnetostrictive component bonded to at least one electroactive component.

2. The apparatus of claim 1, wherein:
said first device is a transmit device that generates a magnetic dipole field at a carrier frequency that corresponds to a resonance frequency of the ME device.

3. The apparatus of claim 2, said first device further comprising:
a circuit for modulating a current or carrier frequency of the transmit device, said modulation carrying the information.

4. The apparatus of claim 3, wherein:
said second device is an ME receiver device operable at the resonance frequency of the transmission from the transmit device.

5. The apparatus of claim 4, said second device further comprising:
a circuit that demodulates a voltage signal output of the ME device to reveal the information transmitted by the first device.

6. The apparatus of claim 1, wherein:
the ME device is further adapted to wirelessly transmit or receive electrical power.

7. The apparatus of claim 1, wherein:
the ME device has a resonance quality factor Q>100.

8. The apparatus of claim 1, wherein:
said first device is a transmit device and further comprises a circuit for modulating a current or carrier frequency of the transmit device, said modulation carrying the information;
said second device is an ME receiver device and further comprises a circuit for demodulating a voltage signal output of the ME receiver device to reveal the information transmitted by the first device.

9. The apparatus of claim 1, wherein:
said ME device comprises a plurality of ME devices.

10. The apparatus of claim 1, wherein:
said ME device includes a bias magnet.

11. The apparatus of claim 1, wherein:
said ME device is a thin-film deposition device.

12. The apparatus of claim 1, wherein:
said magnetostrictive component is of an amorphous material.

13. The apparatus of claim 1, wherein:
said electro-active component is of a hard, high Q piezoelectric material.

14. The apparatus of claim 13, wherein:
said piezoelectric material is a PZT ceramic, single crystal relaxor, or quartz.

15. The apparatus of claim 1, wherein:
said information is voice or data.

16. A method comprising:
a first device that transmits analog or digital information by wireless near-field magnetic communication (NFMC) to a second device;
the second device receiving said NFMC transmission from the first device;
wherein at least one of the first and second devices comprises a magneto-electric (ME) device having at least one magnetostrictive component bonded to at least one electro-active component.

17. The method of claim 16, comprising:
said first device is a transmit device that generates a magnetic dipole field at a carrier frequency that corresponds to a resonance frequency of a receiver ME device.

18. The method of claim 17, comprising:
said second device is an ME receiver device operable at the resonance frequency of the transmission from the transmits device.

19. The method of claim 17, comprising:
the ME device wirelessly transmits and/or receives electrical power.

20. The method of claim 17, comprising:
said information is voice or data.
